(19) United States
(12) Patent Application Publication
(10) Pub. No.: US 2004/0205669 A1
(43) Pub. Date: Oct. 14, 2004

(54) Arrangement to perform object-oriented programming

(76) Inventor: Lars Hoidahl, Uppsala (SE)

Correspondence Address: Matthew A. Pequignot, Esquire, Hall, Priddy, Myers & Vande Sande, 10220 River Road, Ste. 200, Potomac, MD, 20854, US

(21) Appl. No.: 10/208,244

(22) Filed: Jul. 31, 2002

(30) Foreign Application Priority Data
Aug. 2, 2001 (SE) 0102648-3

(51) Int. Cl. G06F 15/00

(52) U.S. Cl. 715/531

(57) ABSTRACT

A problem with textual programming is that it is hard to get an overview of the code and it is very easy to type something wrong. With the present invention the problem can be solved by drawing object-oriented diagrams instead of typing text. There is a need for a tool converting diagrams to text.

### RELATED APPLICATION DATA

This application claims priority of Swedish Patent Application No. 0102648-3, filed on Aug. 2, 2001.

### BACKGROUND OF THE INVENTION

It is known that there is a problem with textual programming that it is very easy to type something wrong. Textual programming languages define strict rules for what is allowed to type and what it means, but the programmer can easily type something that breaks these rules. By using visual programming instead, a drawing tool can give the programmer much fewer options, i.e. only legal ones. This prevents the programmer from doing many of the common errors.

The present invention will solve the problem and it will be described a method and tool that can be used to perform object-oriented programming by drawing diagrams instead of typing text. The diagrams are changed step by step like a cartoon to illustrate the dynamic behavior of programs. The tool can automatically generate text in a programming language based on these diagrams. The text is then compiled or interpreted with standard tools to build an executable program. It is also possible to combine the tool with a compiler or interpreter so that it can generate an executable program directly without generating textual code first.

This invention makes programming easier because the human mind understands diagrams easier than text. For this reason, diagrams are used a lot in software development to design the structure of the program and to get an overview of the textual code. But the programmer has to work in two different views of the program: diagrams and text. And when changes are made in either view, the other view needs to be updated accordingly. By using the principles in this document, the programmer can work in diagrams almost all the time. This is first of all easier and it also eliminates the need to work in two different views and to synchronize these views.

Textual programming is performed as follows: Programmers type text and the text is compiled or interpreted automatically into executable programs. This is illustrated in FIG. 1.

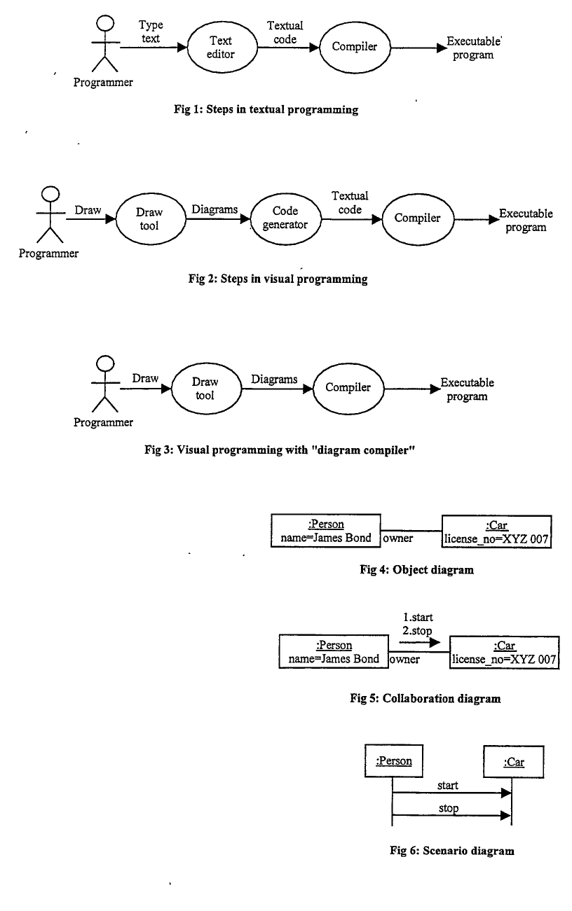

There is proposed a method and tool that allows the programmer to program by drawing diagrams, see FIG. 2. These diagrams are then used to automatically generate textual code. This process is often called forward engineering. This textual code be compiled or interpreted into an executable program with known tools.

There is also proposed that a tool can compile or interpret the diagrams directly without generating code as an intermediate step. This is illustrated in FIG. 3.

There is also proposed methods and tools that can generate diagrams from textual code or executable programs. This process is often called reverse engineering. There are several ways to do this:

a) A tool can generate diagrams automatically from textual code.

b) It is possible to generate textual code from executable programs with known technology. This text can be used as input to generate diagrams.

c) A tool can generate diagrams automatically by static analysis of an executable program. This is the same as performing a) and b) in one operation without going via textual code.

d) A tool can generate diagrams automatically by dynamic analysis of a program that is executing.

The tool can display these generated diagrams for a programmer and let the programmer use the diagrams as basis for further visual programming.

Terminology

Association—A relationship between classes. An association is drawn as a line between the class symbols.

Attribute—Information that is stored in a class. It is drawn as text in the class symbol.

Attribute value—Information that is stored in an object. It is drawn as text in the object symbol.

Class—A specification of what information and behavior objects of the class may have.

Variable—An association or an attribute. The difference between these is in the presentation (how they are drawn). A variable could be drawn both as a line between classes or as text in a class.

Link—A relation between objects. A link is drawn as a line between object symbols.

Message—Information that is sent between objects.

Object—An entity that contains information and/or has behavior. An object is an instance of a class.

Object-oriented—A way of organizing software programs as a collection of objects that cooperate.

Operation—A specification of behavior.

UML—The Unified Modeling Language.

Visual, visualize—To describe something with graphical symbols, as opposed to with text.

More About Known Technology

In object-oriented programming, the information and behavior of a program is organized as objects. Each object may store information and communicate with other objects by sending and receiving messages. Object-oriented programming is possible in many programming languages, but some languages, such as Java and C++, give direct support for object-oriented features.

It is common to draw diagrams of a program to get an overview of the textual code. This can be compared to drawing blueprints before building a house. There are several methods for drawing object-oriented diagrams. One of the most known standards is called UML. It defines several types of diagrams. Some of the diagrams model the static structure of the program, while others model the dynamic behavior. Three of these diagrams are object diagrams, collaboration diagrams and scenario diagrams.

Object diagrams may contain objects, attribute values and links, see FIG. 4. Objects are visualized as rectangles, links are visualized as lines between the objects and attribute values are visualized with text inside the objects. An object diagram displays a static “snapshot” at a specific moment in time.

Collaboration diagrams are similar to object diagrams, but they can also display messages between objects, see FIG. 5. Messages are visualized as arrows together with the name of the message. Parameters to the message may also be displayed. The messages may have numbers that indicate their sequence of execution (time). The messages visualize dynamic behavior.

Scenario diagrams display objects and messages that are sent between objects, see FIG. 6. The objects are visualized as rectangles that are distributed along the X-axis at the top of the diagram. Each object has a vertical line below it. Messages are shown as arrows between these lines. The Y-axis is used to indicate the sequence of execution (time): The messages are sent in order from top to bottom.

Scenario diagrams can visualize that objects are created, destroyed or that attribute values are changed at different points in time. Scenario diagrams cannot visualize links. The sequence of messages visualize dynamic behavior.

The limitation of current technology is that it cannot visualize much of the dynamic behavior of objects. Collaboration and scenario diagrams cannot visualize all of the internal behavior of objects. Scenario diagrams can visualize objects and attribute values at different points in time, but they cannot display links.

Existing tools can be used to draw some diagrams and generate some textual code from the diagrams. The following is an example of Java code that can be generated by such a tool:

class Person
{
String name;
}
class Car
{
Person owner;
void test( ) { }
void start( ) { }
void stop ( ) { }
}

This code is like a skeleton and the programmer has to fill in the details inside the functions test, start and stop. This document will describe how these details can be generated from diagrams.

### DETAILED DESCRIPTION OF CERTAIN EMBODIMENTS

Dynamic Object Diagrams

There will be proposed a new type of diagram, which is called dynamic object diagrams. This diagram is like an object or collaboration diagram that is changed step by step. This diagram visualizes the dynamic changes of the object structure (objects, attribute values and links) in a diagram that is changing. Messages are also visualized in the diagram. The flow of a software program is partly sequential, partly dependent on various conditions. The designer can navigate back and forth in the diagrams sequence and “int( )” and “out of” conditional blocks to specify and see how the object structure will be changed when the program is running.

The diagram can be built by a programmer in a tool. The tool can then generate programming code automatically from the diagram. The code can be generated in many languages and in many different ways. The code shown in this document is only examples. This code is compiled or interpreted with standard tools to generate executable programs.

It is also possible to analyze textual code, a compiled program or an executing program to generate this kind of diagrams. The diagrams can then be used to illustrate the behavior of the program and as basis for further visual programming.

### EXAMPLE

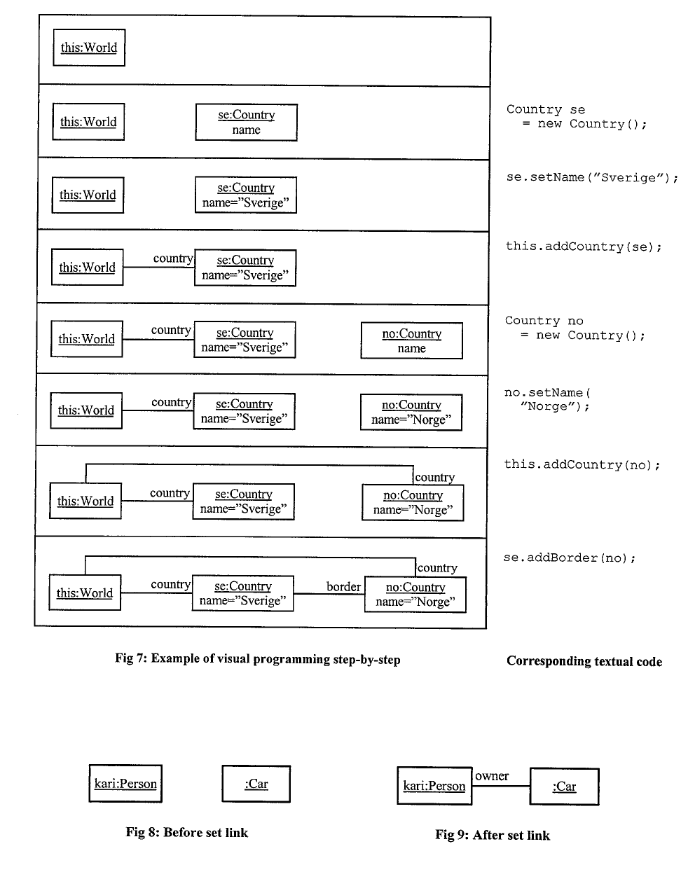

The following diagrams show an example of how the behavior of a program can be illustrated in a diagram that is changed step by step, see FIG. 7. Each step corresponds to textual code and an example of code that can be generated automatically from the diagrams is displayed beside each step. The code that is listed in FIG. 7 can be used as part of a program, as in the following example:

```
class Country
{
    private String name;
    public void setName(String s) { name = s; }
    public String getName( ) { return name; }
    private Vector border = new Vector( );
    public void addBorder(Country c) { border.add(c); }
  }
  class World
  {
    private Vector country;
    public void addCountry (Country c) { country.add (c); }
    public void init ( )
    {
      Country se = new Country ( );
      se.setName (“Sverige”);
      this.addCountry (se);
      Country no = new Country ( );
      no.setName (“Norge”);
      this.addCountry (no);
      se.addBorder (no);
    }
}
```

Operations

A dynamic object diagram specifies the behavior of one or more operations. The programmer may specify an operation in a class as the “scope” of the diagram. The programmer may do this by selecting an operation or message that is displayed in a diagram, in a list or in text, by typing the operation name etc. The programmer may specify different operations for different parts of the behavior that is specified in the diagram. The tool will use this information to generate textual code in the operations that are specified or to generate interpreted or compiled code for those operations.

Objects

An object is drawn as a rectangle or another symbol in the diagram. The symbol may contain text that specifies the name of the object, its class, attributes, attribute values, operations and other information.

Each operation that is member of a class has at least one object available: The object that is performing the operation. Put another way, this is the object that received the message that initiated the operation. In C++ and Java, this object is called “this”.

When a dynamic object diagram has a member operation as “scope”, an object called “this” of the class of that operation will be displayed automatically in the diagram. Whenever that object is used, the text “this” or corresponding can be generated in textual code. Often, the text can be omitted, because “this” is the default object name for behavior in member operations. The “this” object may also be available in the diagram as the receiver of the message that is set as the “scope”.

When an object is used in a dynamic object diagram, the name of that object will be used in the generated textual code. The name of an object may either be “this” (as explained above) or it may be generated by information, rules and templates that are predefined or user-defined for the class of the object, for the object itself or for a link to that object. If there are several possible names for an object, the programmer may choose which one to use by selecting one of the links, by selecting in a list etc. The programmer may also choose not to make an explicit selection and let the program use a default name for the object.

Links

A link is drawn as a line between two objects. The line may have text attached to it that specifies the name of the link and other information. There are several types of links, as described below.

A link may be an instance of an association that is defined between classes or superclasses of the objects that the link connects. When such a link is used in a diagram, the tool will generate textual, interpreted or compiled code based on information, rules or templates that are predefined or user-defined for the association or link. Examples of information that is defined for an association are “role names” and “multiplicity”. A role “name” is a name that is defined for the class in one end of an association. The “multiplicity” specifies how many objects may exist on either end of the association.

A link may be a local variable in an operation. The programmer may define such variables in the dynamic object diagram and specify the type, name, multiplicity and “scope” of the variable. The “scope” means which part of the operation the variable is available. Local variables may also be found by the tool in the text or executable code.

A link may represent a parameter to an operation. The parameter may be input and/or output to the operation. Inside the operation, the link name will be the name of that parameter. Outside the operation (for the caller of the operation), the link name may be the name of that parameter or it may represent a parameter number that has no explicit name. In this document, the term “link name” will be used although it may be mapped to a parameter position in the generated code.

A link may represent a return value or exception from an operation. In the textual code, this may be mapped to a “return” statement, a “throw” statement, a “catch” statement, to receive a returned value etc.

A link may represent one ore more objects that are found during execution. Examples of this are described in points G and H below.

A link may represent programming code that is specified by the user as text and/or visual modeling or that is generated automatically by the tool based on input from the user, existing textual code or executable program.

The user may select a link by selecting a link symbol in a diagram, by selecting in a list of links or associations that is available for a specific object, by selecting text represents the link, by typing the link name etc.

Attributes

Attributes can be displayed as text in object symbols. There are different kinds of attributes as described below.

Each object has attributes that are members of the class or a superclass of that object. An attribute may be designed by the programmer or generated automatically from textual or executable code. When such an attribute is used in a diagram, the tool will generate textual, interpreted or compiled code based on information, rules or templates that are predefined or user-defined for the attribute. Examples of information that is defined for an attribute are name, type and multiplicity. The “multiplicity” specifies if the attribute has one value or several values (for examples an array).

An attribute may be a local variable in an operation. The programmer may define local variables and define the type, name and “scope” of variable. The “scope” means which part of the operation the variable is available. Local variables may also be found by the tool in the text or executable code.

The programmer may select an attribute in the object symbol, in a list of attributes, by selecting text that represents attribute, by typing the attribute name etc.

A tool can let the programmer draw diagrams as described in the following points A-H. The tool can use the diagrams to generate textual code in a programming language, as specified in each point. The textual code can then be used by an interpreter or compiler to generate executable programs. Alternatively, the tool can be directly connected to a regular interpreter or compiler to generate executable programs or execute behavior immediately that is specified in the diagrams and/or specified textually without generating textual code first.

One way to execute behavior immediately is by using Java “reflection”. This means that executable Java classes can be detected and used at runtime. Since the classes, objects, methods, links and attributes are displayed in the dynamic object diagrams, the tool has access to all the information that is necessary to create objects, call methods and set fields by use of “reflection”. The tool can combine this with expression evaluation to handle any programming expression, for instance “x=a.calculate(100,y)+46”, etc.

Common to all the points is that some information is specified by the user by drawing diagrams. This is typically objects, attributes and links. These elements are associated with predefined or user-customizable information, rules and templates on how to generate textual, interpreted or compiled code. The tool uses this to build textual code or compile or interpret into executable format.

A tool can also go the other way by analyzing textual or executable code as described in point A-H and generate dynamic object diagrams automatically. Regular text parsing and disassembler technology can be used to accomplish this. The diagrams can be displayed to a programmer to illustrate the programs behavior. The programmer can also use the diagrams as basis for further visual programming.

A tool can also analyze executing programs and generate dynamic object diagrams automatically. The diagrams can be displayed to a programmer to illustrate the programs behavior. The programmer can also use the diagrams as basis for further visual programming. One way to do this is by using Java “reflection”, which makes it possible to get information by calling methods and getting fields and to detect exceptions. There are other ways to get the information necessary to draw the diagrams, for example by executing the program in a debugger and analyzing information from the debugger.

Point A-C describe behavior that cannot be visualized in neither object, collaboration nor scenario diagrams.

Point D-F describe behavior that cannot be visualized in neither object nor collaboration diagrams or it can only be visualized as messages, which doesn't show the structural change. The behavior can be visualized in scenario diagrams, but scenario diagrams cannot display links, so some of the structure (links) cannot be displayed together with the dynamic behavior.

Point G-H describe conditional or iterative behavior. This cannot be visualized in object nor collaboration diagrams. It could be visualized in scenario diagrams, but not together with links.

A. Set a Link Between Two Objects.

The programmer draws a line between two objects. See FIGS. 8 and 9. The objects and the link have predefined or user-defined information, rules and templates that the tool uses to generate code for setting a link. For example, a link with name “owner” can be used to generate textual code such as “setOwner( )”, “owner=” or “addOwner( )”. Such text can also be parsed by the tool to generate diagrams. Examples by Java code are:

```
  owner = kari;
or:
  setOwner (kari);
or:
  this.setOwner (kari);
or:
  this.addOwner (kari);
```

B. Remove a Link Between Two Objects.

The programmer removes a link between two objects. An example would be to change FIG. 9 to FIG. 8. The objects and the link in the diagram have predefined or user-defined information, rules and templates that the tool uses to generate code for removing a link.

For example, a link with name “owner” can be used to generate textual code such as “setOwner(null)”, “owner=null” and “removeOwner( )”. Such code can also be parsed by the tool to generate diagrams. Examples of Java code are:

```
  owner = null;
or:
  this.setOwner (null);
or:
  this.removeOwner (kari);
```

C. Change a Link

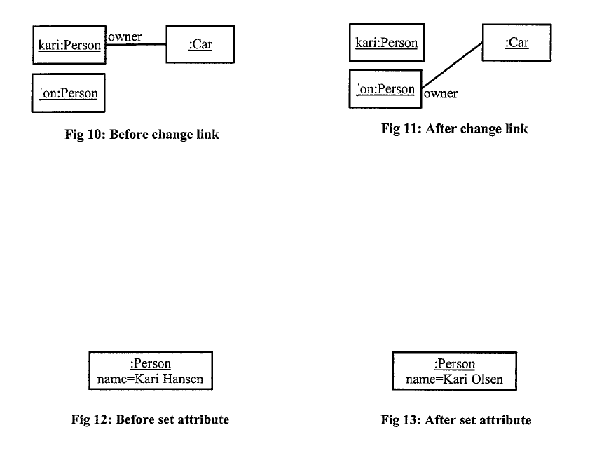

The programmer moves a line from one object to another. See FIG. 10 and 11. The objects and the link in the diagram have predefined or user-defined information, rules and templates that the tool uses to generate code for changing a link.

The textual code is a combination of the code in A and B. Such code can be generated by the tool or parsed by the tool to generate diagrams. Examples of Java code are:

```
  owner = jon;
or:
  this.setOwner(jon);
or:
  this.removeOwner(kari); this.addOwner(jon);
```

D. Set Value of an Attribute in an Object or a Local Variable.

The programmer modifies text in an object symbol. See FIGS. 12 and 13. The object has predefined or user-defined information, rules and templates that the tool uses to generate code for setting an attribute to the value that the programmer defines.

For example, an attribute with name “name” can be used to generate textual code such as “setname( )” or “name=”. Such text can also be parsed by the tool to generate diagrams. Examples of Java and C++ code are:

```
  name = “Kari Olsen”;
or:
  this.setName (“Kari Olsen”);
```

E. Create an Object.

The programmer selects a class, optionally selects a constructor for the class, draws a symbol and specifies parameters to the constructor. The class, constructor and parameters have predefined or user-defined information, rules and templates that the tool uses to generate code for creating an object.

This can be combined with A or C to store the new object in a variable, For example, a class with name “Car” can be used to generate textual code such as “new Car( )”. Such text can also be parsed by the tool to generate diagrams. An example of Java or C++ code is:

new Car(“Volv( )”);

F. Destroy an Object.

The programmer removes an object from the diagram. The object, class or superclass may have predefined or user defined information, rules and templates that the tool uses to generate code for destroying the object.

For example, an object with name “c” can be used to generate textual code such as “delete c”. Such text can also be parsed by the tool to generate diagrams. An example of C++ code is:

delete c;

G. Conditional Execution.

This means that a part of the program should only execute if a specified condition is true. There are different kinds of conditions.

G.1. Conditional Execution if a Specified Object Exist.

The programmer selects an association or other variable that may or may not have an associated object during execution and selects a specific command. The programmer draws a link to the object or the tool draws a link to the object automatically. The programmer may now model any behavior as described in this document or by typing textual code. Finally, the programmer selects a command to end the conditional behavior. Then, the link to the object is removed. Any visual behavior that was modelled as part of the conditional execution are also removed.

The object and the association have predefined or user-defined information, rules and templates that the tool uses to generate code for conditional execution.

For example, an association with name “c” can be used to generate textual code such as “if(c!=null)” or “if(getC( )!=null”. Such text can also be parsed by the tool to generate diagrams. An example of Java code is:

if (c !=null)
{
}

The conditional behavior is placed between the braces in the text.

G.2 Conditional Execution if a Specified Condition is True.

The programmer selects a command to define a condition and defines the condition as text. The programmer may now model any behavior as described in this document or by typing textual code. Finally, the programmer selects a command to end the conditional behavior. Then, any visual behavior that was modelled as part of the conditional execution are removed.

H. Iterative Execution.

This means that part of the code should execute several times.

H.1 Iterate the Objects in a Collection.

The programmer selects an association or other variable that represents any number of objects and selects a specific command. The programmer draws a link to an object or the tool draws a link to an object automatically. The link and object represents an object in the collection. This link and object may be used to access each object in the collection iteratively. The programmer may now model any behavior as described in this document or by typing textual code. Finally, the programmer selects a command to end the iteration. Then, the link to the object is removed. Any visual behavior that was modelled as part of the iteration are also removed

The association has predefined or user-defined information, rules and templates that the tool uses to generate code for iterating a collection.

For example an association with name “cars” can be used to generate textual code such as “getCars( ).length”, “getCars( )[ ]”, “getCar( )”, “cars[ ]”, “cars.iterator( )” or “iterateCars( )”. Such text can also be parsed by the tool to generate diagrams. Examples of Java code are:

```
  for(int i = 0; i < getCars( ).length; i++)
  {
    Car c = getCars( ) [i];
  }
or:
  for (Iterator i = cars.iterator( ); i.hasNext( );)
  {
    Car c = (Car)i.next( );
  }
```

H.2. Iterate the Elements in an Array.

The programmer selects a class or object and an array in that class or object and selects a specific command. The tool automatically draws an attribute that represents one element in the array. That attribute may be used to access each element in the array iteratively. The programmer may now model any behavior as described in this document or by typing textual code. Finally, the programmer selects a command to end the iteration. Then, the attribute is removed. Any visual behavior that was modelled as part of the iteration are also removed.

The class, object and attribute have predefined or user-defined information, rules and templates that the tool uses to generate code for iterating the array. For example, an attribute with name “cars” can be used to to generate textual code such as “getCars( ).length”, “getCars( )[ ]”, “get Car( )”, “cars[ ]”, “cars.iterator( )” or “iterateCars( )”. Such text can also be parsed by the tool to generate diagrams. Examples of Java code are:

for (int i = 0; < cars.length; i++)
{
Car c = cars [i];
}

H.3. Iterative a Specified Number of Times.

The programmer selects a specific command and defines some text that specifies how many times the iteration should be executed. The tool automatically draws a symbol that represents the iterative block. The programmer may now model any behavior as described in this document or by typing textual code. Finally, the programmer selects a command to end the iteration. Then, any visual behavior that was modelled as part of the iteration are removed.

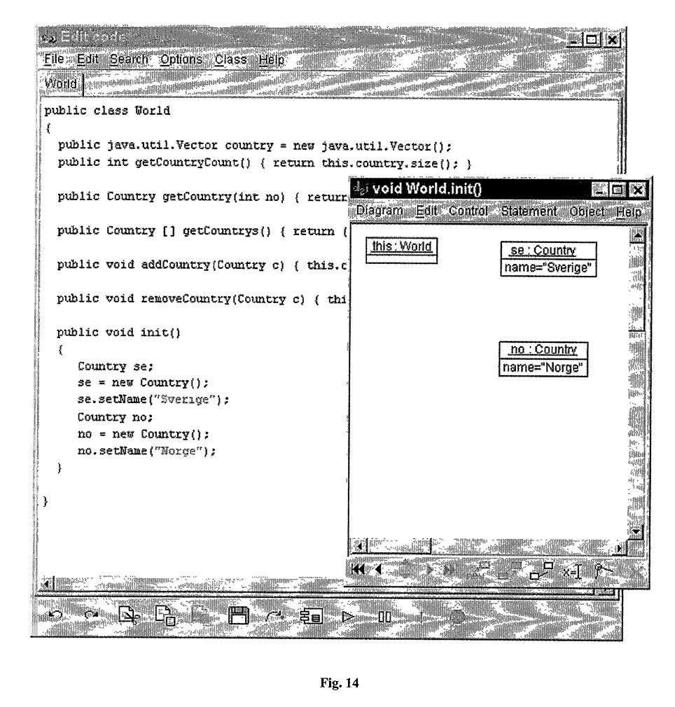

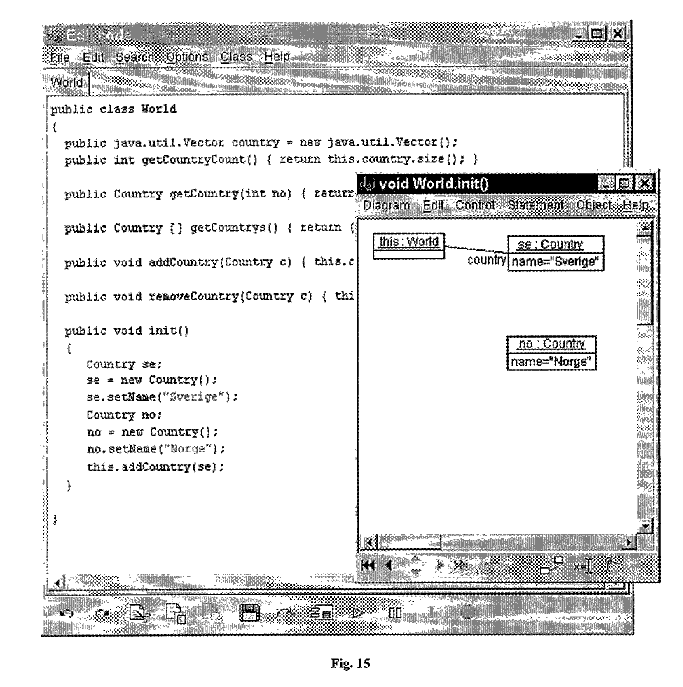

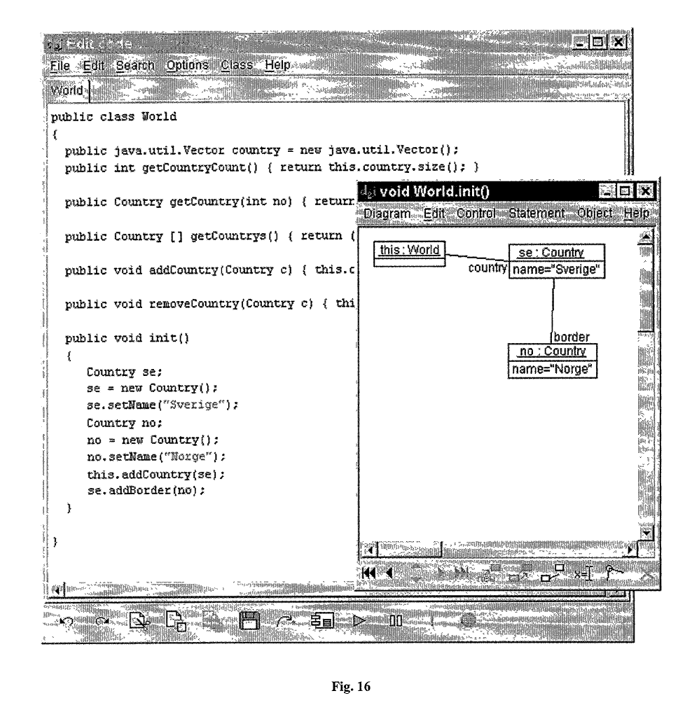

In the FIGS. 14, 15 and 16 there are shown screenshots showing how the programmer draws symbols in a drawing tool and how the tool use these symbols to generate textual code.

The second tool, which collaborates with both diagram and text can also be used separately in any arbitrary arrangement.

Once given the above disclosure, many other features, modifications, and improvements will become apparent to the skilled artisan. Such other features, modifications, and improvements are therefore considered to be a part of this invention, the scope of which is to be determined by the following claims:

1. Arrangement to perform object-oriented programming,
characterized by a first tool that receives either text and for drawn diagrams and/or executable code and by a second tool that receives diagrams and converts them into text.

2. Arrangement according to claim 1,
characterized by a diagram being directly supplied to a compiler.
